(19) United States
(12) Patent Application Publication
(10) Pub. No.: US 2026/0179410 A1
(43) Pub. Date: Jun. 25, 2026

(54) FACIAL EXPRESSION RECOGNITION METHOD AND APPARATUS VIA LABEL DISTRIBUTION LEARNING

(71) Applicant: KOREA UNIVERSITY RESEARCH AND BUSINESS FOUNDATION, Seoul (KR)

(72) Inventors: Han Seok KO, Seoul (KR); Bon Hwa KU, Seoul (KR); Hyun Uk SHIN, Seoul (KR)

(21) Appl. No.: 19/059,129

(22) Filed: Feb. 20, 2025

(30) Foreign Application Priority Data
Dec. 24, 2024 (KR) 10-2024-0196037
Feb. 5, 2025 (KR) 10-2025-0014407

(51) Int. Cl. G06V 40/16; G06N 20/00; G06V 10/774

(52) U.S. Cl. CPC G06V 40/174; G06N 20/00; G06V 10/774; G06V 40/168

(57) ABSTRACT

Facial expression recognition method and apparatus via label distribution learning are disclosed. The facial expression recognition method through label distribution learning, comprising: (a) in the training process, preprocessing an input sample to generate a plurality of augmented samples, creating a target label distribution for the input sample using the plurality of augmented samples, and training a model using supervised learning; and (b) after the training is completed, during the inference process, outputting a facial expression recognition result by inputting a single facial sample into the trained model without using the augmented samples.

### CROSS-REFERENCE TO RELATED APPLICATION

This application claims the benefit of priority under 35 U.S.C. § 119(a) to Korean Patent Application Nos. 10-2024-0196037 filed on Dec. 24, 2024 and 10-2025-0014407 filed on Feb. 5, 2025, the entire contents of which are incorporated herein by reference.

### BACKGROUND

### (a) Technical Field

The present disclosure relates to a facial expression recognition method and apparatus via label distribution learning.

### (b) Background Art

Emotions are social and evolutionary products of human beings and play an important role in communications. In particular, facial expressions play a major role in emotions. Humans are mostly good at recognizing expressions, but this is no trivial task for machines. Facial expression recognition is essential to developing proficient human-computer interaction. According to Paul Ekman, human emotions consist of seven basic emotions: anger, happiness, surprise, fear, disgust, sadness, and neutral, and facial expression are expressed in the same way.

Recently, deep learning has been used in various fields due to the development of sophisticated algorithms and technologies. In addition, great progress has been made with the application of deep learning in emotion recognition using vision, speech, and multi-modal. It is also used in facial expression recognition (FER) and contributes to improving the performance of deep learning-based FER with large-scale datasets such as AffectNet, RAF-DB, EmotioNet.

However, FER still suffers from the label inconsistency problem caused by the uncertainty contained in large FER datasets. There are several reasons for uncertainty in large FER datasets. First, facial expressions can be subjectively expressed or recognized by various backgrounds of the subjects of facial expressions or annotators such as race, gender, and age differences. Second, during data collection, low-quality facial images or ambiguous facial expression images are often collected, making accurate classification into specific categories challenging. Third, datasets collection in real-time environments complex emotions expression rather than only one exaggerated basic expression.

Referring FIG. 1, (a) is labeled differently due to subjective differences in expression, (b) represents a case where the facial image is low-quality, making it difficult to recognize the expression, (c) looks like a compound expression that is difficult to classify as a single emotion.

Large FER datasets have a lot of noise in the labels. Therefore, to train an FER model in the noisy label environment, it may be more effective to use label distributions represented across multiple categories as supervision signals rather than a single label. However, most existing large-scale FER datasets provide only a single label for each sample instead of a label distribution.

### SUMMARY OF THE DISCLOSURE

The present disclosure is to provide a facial expression recognition method and apparatus via label distribution learning.

Further, the present disclosure is to provide a facial expression recognition method and apparatus using label distribution learning, which generates augmented samples for training samples during the training process and supervises the model by creating a new label distribution using the augmented samples.

Further, the present disclosure is to provide a facial expression recognition method and apparatus using label distribution learning, which enables the creation of an effective target label distribution by generating a new label distribution with augmented samples without additional annotations and reflecting the provided labels according to uncertainty.

According to an embodiment of the present disclosure, there is provided a facial expression recognition method via label distribution learning.

According to an embodiment of the present disclosure, there may be provided a facial expression recognition method through label distribution learning, comprising: (a) in the training process, preprocessing an input sample to generate a plurality of augmented samples, creating a target label distribution for the input sample using the plurality of augmented samples, and training a model using supervised learning; and (b) after the training is completed, during the inference process, outputting a facial expression recognition result by inputting a single facial sample into the trained model without using the augmented samples.

The step (a) includes: extracting a facial feature and a plurality of augmented facial features by inputting the input sample and the plurality of augmented samples into backbone network of the model, respectively; calculating an importance weight for each of the plurality of augmented samples using the facial feature and the plurality of augmented facial features; and generating a target label distribution for emotion classes by reflecting the importance weight for each augmented sample based on the facial feature and the plurality of augmented facial features, and using the generated target label distribution to supervise the training of the model.

The step generating the target label distribution comprises: generating a predicted label distribution for each of the plurality of augmented samples by inputting the plurality of augmented facial features corresponding to each of plurality of augmented samples into the fully connected layer, respectively; generating the target label distribution by calculating a weighted sum using between the predicted label distribution and importance weight for each of the plurality of augmented samples, and then normalizing the result; and generating a final target label distribution for the input sample by reflecting one-hot label of the input sample in the target label distribution, considering an uncertainty score of the input sample.

The step calculating importance weight for each augmented sample for comprises: calculating importance weight for each of the augmented samples by combining each augmented facial feature with the facial feature, respectively, and inputting the combined result into an importance feature extractor; and normalizing the importance weight for each of the augmented samples by sorting the importance weights of each augmented sample in descending order and dividing them two groups, calculating the weighted average of the importance weights for each group, and adjusting the importance weights such that the weighted averages of the two groups have a minimum margin.

The model is trained by adding a loss term to a loss function so that the distance between emotion class-centered vectors becomes larger.

According to another embodiment of the present disclosure, there is provided an apparatus for performing a facial expression recognition method through label distribution learning.

According to another embodiment of the present disclosure, there may be provided a computing device, comprising: a memory storing at least one command; and a processor executing commands stored in the memory, wherein the commands executed by the processor respectively perform: (a) in the training process, preprocessing an input sample to generate a plurality of augmented samples, creating a target label distribution for the input sample using the plurality of augmented samples, and training a model using supervised learning; and (b) after the training is completed, during the inference process, outputting a facial expression recognition result by inputting a single facial sample into the trained model without using the augmented samples.

### BRIEF DESCRIPTION OF DRAWINGS

FIG. 1 is a diagram illustrating some samples with label mismatches in the dataset.

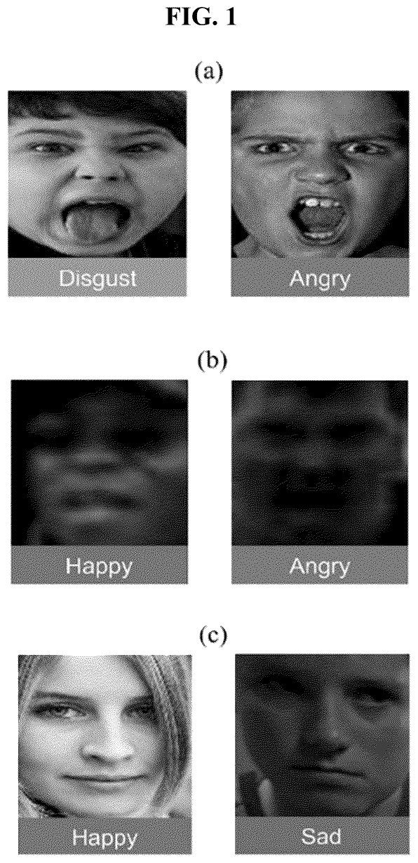

FIG. 2 is a flowchart illustrating a facial expression recognition method through label distribution learning according to an embodiment of the present disclosure.

FIG. 3 is a diagram illustrating the importance weight normalization according to an embodiment of the present disclosure.

FIG. 4 is a diagram showing the model architecture according to an embodiment of the present disclosure.

FIG. 5 is a diagram comparing the facial expression recognition methods according to the conventional and the present disclosure.

FIG. 6 is a diagram comparing the results of injecting noisy labels at specific ratios into the RAF-DB and AffectNet datasets.

FIG. 7 is a diagram showing the results of applying different augmentation methods.

FIG. 8 is a diagram comparing the label distribution learning results based on the number of augmented samples.

FIG. 9 is a diagram showing the evaluation results of each component of the model.

FIG. 10 is a diagram comparing the results of applying different backbone networks.

FIG. 11 is a diagram showing the result of visualizing the feature distribution to validate the training of the model according to the conventional and the present disclosure.

FIG. 12 is a block diagram schematically illustrating an internal configuration of a computing device for performing a facial expression recognition method through label distribution learning according to an embodiment of the present disclosure.

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “˜ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

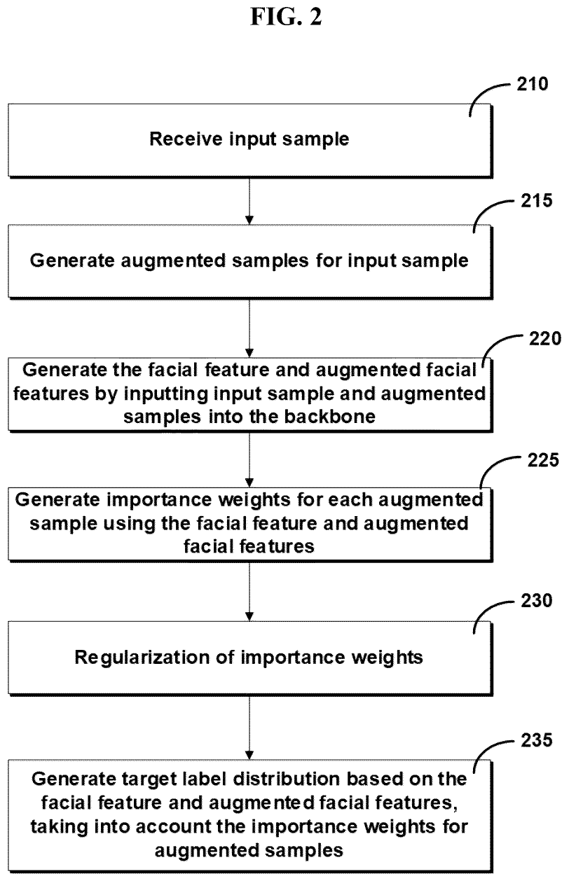

FIG. 2 is a flowchart illustrating a facial expression recognition method through label distribution learning according to an embodiment of the present disclosure.

In step 210, the computing device (200) receives an input sample.

For the sake of clarity and ease of explanation, the training data will be denoted as (x₁,y₁), . . . , (x_{N},y_{N}), xᵢ denotes the i-th sample, and yᵢ∈ [symbol] denotes a one-hot label labeled with a specific single class. Also, N denotes the total number of training samples, and C denotes the number of classes.

In step 215, the computing device (200) generates a plurality of augmented samples for the input sample.

The computing device (200) generates a plurality of augmented samples by preprocessing the input sample. That is, the computing device (200) generates face-specific augmented samples to construct a new label distribution for the input sample. For example, k augmented samples can be generated from the input sample through preprocessing techniques, such as horizontal left-right flipping, random cropping, and the brightness adjustment. For convenience, the augmented samples for xᵢ are denoted as

$${x}_{i}^{1} , … , {x}_{i}^{k} .$$

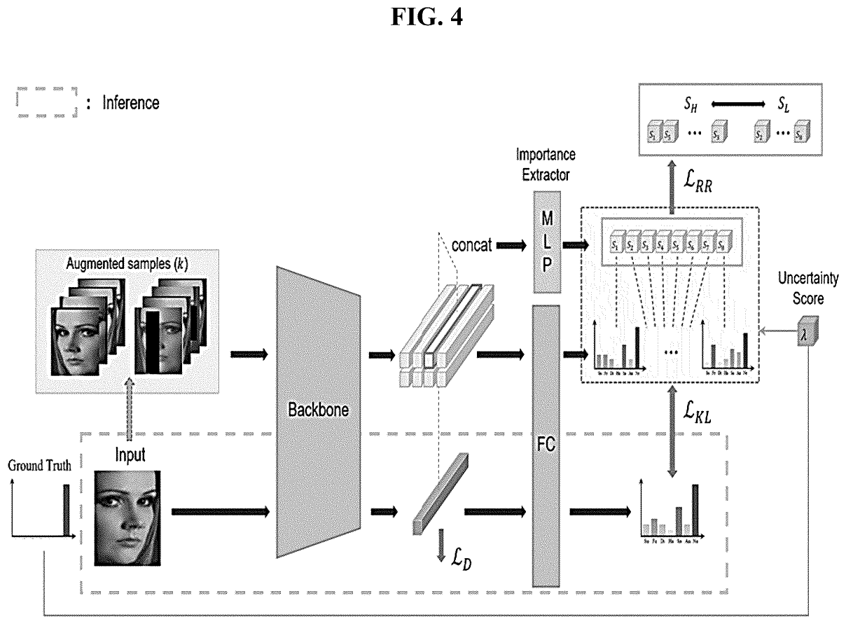

In step 220, the computing device (200) inputs the input sample and augmented samples into backbone respectively to extract facial feature and augmented facial futures respectively. FIG. 4 illustrates the overall architecture of a model according to one embodiment of the present disclosure.

The computing device (200) inputs the input sample xᵢ into backbone of the model to extract facial feature fᵢ. Also, the computing device (200) inputs the k augmented samples

$${x}_{i}^{1} , … , {x}_{i}^{k}$$

into the backbone of the model to extract augmented facial features

$${f}_{i}^{1} , … , {f}_{i}^{k} .$$

Therefore, in training of the model can be extracted facial feature fᵢ and k augmented facial features

$${f}_{i}^{1} , … , {f}_{i}^{k}$$

for the input sample xᵢ and the k augmented samples

$${x}_{i}^{1} , … , {x}_{i}^{k} .$$

The backbone network itself is a known technology, and the configuration for inputting samples into the backbone to extract features is also a known technology, so a separate explanation of this will be omitted.

In step 225, the computing device (200) calculates importance weights for each augmented sample. This will be explained in more detail.

As shown in FIG. 4, the computing device (200) concatenates the extracted facial feature for the input sample and the augmented facial features for the augmented samples, and then inputs them into an importance feature extractor to calculate the importance weight for each augmented sample. For convivence, the plurality of augmented samples for the input sample will be referred to as the first augmented sample, second augmented sample, . . . , k-th augmented sample. The computing device (200) concatenates the facial feature fᵢ for the input sample and the first augmented facial feature fᵢ¹ for the first augmented sample, and then input concatenated facial feature into the importance feature extractor to calculate the first importance weight

$${s}_{i}^{1} .$$

Also, the computing device (200) concatenates the facial feature fᵢ for the input sample and the second augmented facial feature

$${f}_{i}^{2}$$

for the first augmented sample, and then input concatenated facial feature into the importance feature extractor to calculate the second importance weight

$${s}_{i}^{2} .$$

In other words, the computing device (200) concatenates the facial feature fᵢ for the input sample with each of the augmented facial features, and calculates the importance weights

$${s}_{i}^{1} , ... , {s}_{i}^{k}$$

for each augmented sample.

The importance feature extractor according to an embodiment of the present disclosure can be composed of a multilayer perceptron (MLP) with three layers and a sigmoid activation function. The importance weights calculated through the importance feature extractor can be expressed as Equation 1.

$$\begin{matrix}{s}_{i}^{j} = σ ( M L P ( [ {f}_{i} , {f}_{i}^{j} ] ) ) , & ( j = 1 , ... , k )\end{matrix} \qquad [ Equation 1 ]$$

Herein, [●,●] means concatenation operation, an MLP is a multilayer perceptron composed of 3 layers. Each layer of MLP consists of (512, 256, 1) nodes. In addition, all MLPs are composed of learnable parameters. σ means the sigmoid activation function. The higher the importance weight, the better the augmented sample represents the emotion distribution of the input sample.

In step 230, the computing device (200) regulates the plurality of importance weights calculated for the augmented samples.

The computing device (200) can sort the k importance weights for the k augmented samples in descending order. Herein, the importance weight of each augmented sample has a random value at (0, 1)

The augmented samples that better express the emotion distribution contribute more to the label distribution generation process, while the augmented samples that do not express the emotion distribution well contribute less, thereby enabling the generation of a more effective label distribution.

The computing device (200) can sort the k importance weights for the k augmented samples in descending order and then divide into two groups (high group, low group) using grouping ratio a.

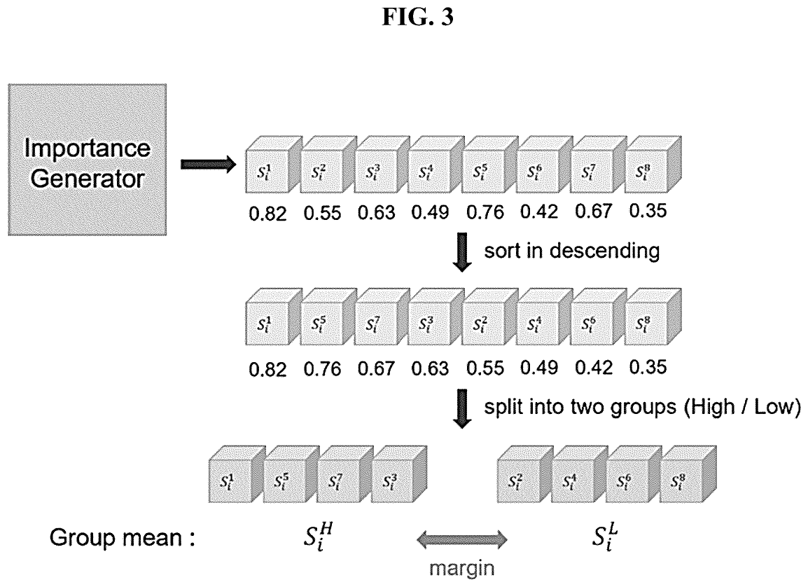

This will be explained with reference to FIG. 3.

For example, the 8 augmented samples will be denoted as

$${s}_{i}^{1} , {s}_{i}^{2} , ... , {s}_{i}^{8} .$$

Assume that the importance wights for each are “0.82”, “0.55”, “0.63”, “0.49”, “0.76”, “0.42”, “0.67”, “0.35”. The computing device (200) can sort the importance wights in descending order. The augmented samples can be split into two groups (Group 1, Group 2).

The Group 1 with high importance weights includes

$${s}_{i}^{1} , {s}_{i}^{5} , {s}_{i}^{7} , {s}_{i}^{3} ,$$

while the Group 2 with low importance weights includes

$${s}_{i}^{2} , {s}_{i}^{4} , {s}_{i}^{6} , {s}_{i}^{8} .$$

The computing device (200) can regularizes the importance weights so that the weighted average of the importance weights in Group 1 and Group 2 has a minimal margin. If the number of importance weights in Group 1 (high group) is α*k, then the number of importance weights in Group 2 (low group) is k−α*k.

The computing device (200) can regularize the average importance weight of the Group 1 (high group) to be higher than the average importance wight of the Group 2 (low group) by more than the margin difference. This can be expressed mathematically as shown in Equation 2.

$${ℒ}_{RR} = {\sum }_{i = 1}^{N} max \{ 0 , margin - ( {s}_{i}^{H} - {s}_{i}^{L} ) \}$$

Here in, margin is a hyper-parameter for the difference between the weighted averages of the two groups. In addition,

$${s}_{i}^{H} and {s}_{i}^{H}$$

mean the weighted averages of the Group 1 (high group) and Group 2 (low group). This can be calculated as shown in Equation 3.

$$\begin{matrix}{s}_{i}^{H} = \frac{1}{( α k )} {\sum }_{i = 1}^{α k} {s}_{i}^{j} , & {s}_{i}^{L} = \frac{1}{( k - α k )} {\sum }_{i = α k + 1}^{k} {s}_{i}^{j} ,\end{matrix} \qquad [ Equation 3 ]$$

In step 235, the computing device (200) generates a target label distribution for input sample using the facial feature and the augmented facial features.

As shown in FIG. 4, the computing device (200) inputs augmented facial features for each augmented sample into a fully connection layer to generate a predicted label distribution for each. The predicted label distributes corresponding to each augmented sample will be denoted as p1, p2, . . . , pk.

The computing device (200) can calculates a weighed sum using the predicted label distribution for each augmented sample and importance weights for each augmented sample, then normalize it so that the sum of the target label distribution becomes 1. This can be expressed mathematically as shown in Equation 4

$$\tilde{{l}_{i}} = \frac{{\sum }_{j = 1}^{k} {s}_{i}^{j} {p}_{i}^{j}}{{\sum }_{j = 1}^{k} {s}_{i}^{j}} , \qquad [ Equation 4 ]$$

Herein,

$${p}_{i}^{j} ∈ {R}^{C}$$

means the predicted label distribution for the j-th augmented sample for i-th input sample.

$${l}_{i} = {λ}_{i} \tilde{{l}_{i}} + ( 1 - {λ}_{i} ) {y}_{i} , \qquad [ Equation 5 ]$$

The final target label distribution is generated by reflecting the label information of the given input sample in the new label distribution generated in the previous process. An uncertainty score for the label of each sample is measured to determine how much the label will be reflected.

In Equation 5, λᵢ (i=1, . . . , N) represents an uncertainty score assigned to each of N training samples, and is trainable parameter with a value in the range [0, 1]. In addition, each parameter λᵢ is initialized to 0.5, and is jointly optimized with the parameters of deep learning model using gradient descent.

A high value of λᵢ indicates that the given label distribution is uncertain, meaning more information from the newly generated target label distribution [symbol] will be used. Conversely, When the value λᵢ is low, the given label distribution can be used more than the target label distribution [symbol] .

The deep learning model according to an embodiment of the present disclosure can be optimized tree loss function [symbol] , [symbol] , [symbol] .

First, [symbol] is the Kullback-Leibler (KL) divergence loss function, which can be calculated as shown in Equation 6.

$${ℒ}_{KL} = {\sum }_{i = 1}^{N} {D}_{KL} ( {l}_{i} \text{\vert \vert} {p}_{i} ) = {\sum }_{i = 1}^{N} {\sum }_{j = 1}^{C} {l}_{i}^{( j )} log ( \frac{{l}_{i}^{( f )}}{{p}_{i}^{( j )}} ) \qquad [ Equation 6 ]$$

The computing device (200) can calculate the difference between the target label distribution for the input sample and the predicted label distribution by the model, as shown in Equation 6. N means the number of the input samples, and C means the number of emotion category classes. As the predicted label distribution pᵢ get closer to the target label distribution lᵢ, the divergence value decreases.

In addition, the computing device (200) can encourage learning discriminative features to improve the ability to discriminate between ambiguous emotions. To reduce intra-class variation for facial recognition, center loss can be used to help the deep learning model learn separable and discriminative features.

The computing device (200) can calculate a discriminative loss function [symbol] as shown in Equation 7.

The discriminative loss function can reduce intra-class variation and enhance inter-class separation. The discriminative loss function, by reflecting the uncertainty coefficient, can adjust the distance between the sample and the center of the sample class to avoid blindly pulling toward the annotated label when the label is uncertain. As a result, uncertain samples are pulled less toward the class center.

In other words, when the label is reliable, the sample is strongly guided toward the class center. If the label confidence is low, the sample maintains a distance that reflects the uncertainty instead of being blindly pulled toward the class center.

Additionally, when designing the discriminative loss function, by including the pairwise distance between the center vector of each class as additional loss term, the differences between different classes can be increased, thereby improving classification performance. In other words, the discriminative loss function encourages the class center vectors to move farther apart by adding the pairwise distance between center vectors in the loss term, reducing class interference and making each class more distinctly separable.

This discriminant loss function can be expressed as Equation 7.

$${ℒ}_{D} = \frac{1}{2} {\sum }_{i = 1}^{N} ( 1 - {λ}_{i} ) {‖ {f}_{i} - {c}^{( {y}_{i} )} ‖}_{2}^{2} + {\sum }_{i = 1}^{C} {\sum }_{j = 1 , j \neq i}^{C} exp ( - \frac{{‖ {c}^{( i )} - {c}^{( j )} ‖}_{2}^{2}}{\sqrt{D}} ) , \qquad [ Equation 7 ]$$

Herein, c^{(yis i)}, c⁽ⁱ⁾, c^{(j)}∈R^{D} are the center vectors of the yᵢ, i, j classes, respectively. All center vectors are initially set to zero and optimized by Equation 7.

Additionally, a rank regularization loss function [symbol] is used to regularize the rank of the importance weights. The rank regularization loss function is as shown in Equation 2 above.

Therefore, the final loss function is calculated using [symbol] , [symbol] , and [symbol] . This can be expressed as in Equation 8.

$${ℒ}_{total} = {ℒ}_{KL} + {γ}_{1} {ℒ}_{D} + {γ}_{2} {ℒ}_{RR} \qquad [ Equation 8 ]$$

Herein, γ₁ and γ₂ mean hyper-parameter to balance the loss functions.

To summarize, the computing device (200) generates the plurality of augmented samples for the input sample during the training process, creates label distributes for those augmented samples, and trains the model in a supervised manner.

Once this training process is complete, the computing device (200) can input a single facial sample into the trained model and output the facial expression recognition result. In other words, during the inference process, the steps of generating augmented samples and creating new label distribution are not performed, as these are only carried out during the model's training process.

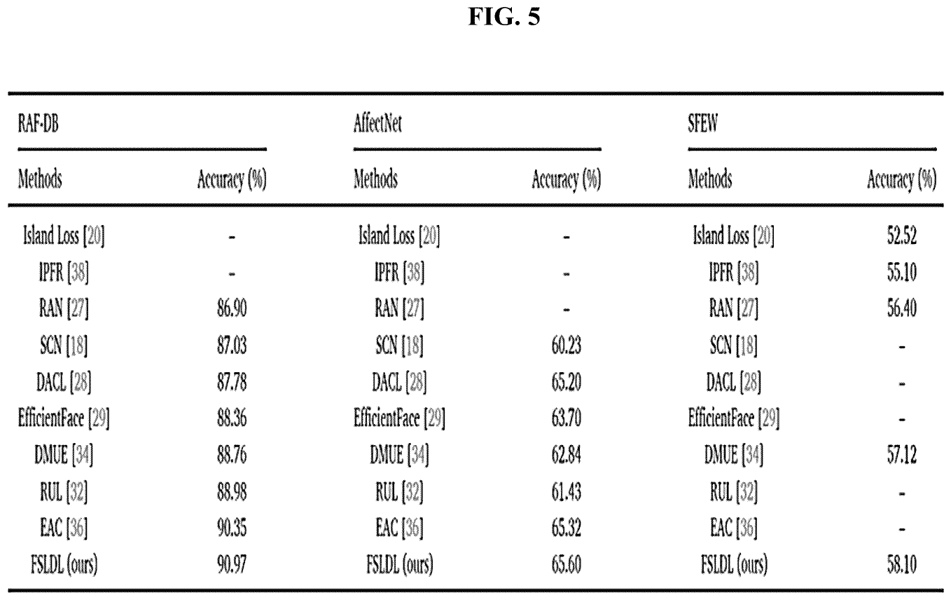

FIG. 5 compares the facial expression recognition method according to an embodiment of the present disclosure with conventional method. In the following experiment, the RAF-DB datasets, which consists of 29,672 real expression images collected from Flickr, were used. The labels include both single and composite labels. For the experimental comparison, a total of 15,339 single-label data (12,271 training data and 3,068 test data) were used, which designated as six basic expressions (surprise, fear, disgust, happiness, sadness, anger) and neutral expressions.

Additionally, AffectNet, the largest FER dataset collected by searching for emotional expression-related keywords on three Internet search engines. 287,651 training data and 3,999 validation data are labeled with seven default facial expressions (surprise, fear, disgust, happy, sad, angry, contempt) and neutral facial expressions. Accordingly, 7 facial expression excluding contempt were used, and since the test data was not disclosed, the verification data was used as the test data.

SFEW is a static facial expression data set collected from scenes in a movie consisting of 958 training data, 436 validation data, and 372 test data. The facial expression category of SFEW consists of six basic expressions and neutral expressions like RAF-DB. Since the label was not assigned to the published test data, the performance was compared using the validation data.

Additionally, the size of the input sample is adjusted to 112×112. For the resized input samples, facial specific augmented samples were randomly generated through transformation such as random cropping, horizontal flipping, random erasing, and adjustment in brightness/contrast/hue/saturation, to create new label distributions. A total of k=8 augmented samples are generated and input into the model. The CNN backbone network used ResNET-50. To optimize the model, the initial learning rate is set to 1e-4, the total learning is set to 60 epochs, and the learning rate is set to decrease by 0.1 every 10 and 30 epochs. The mini-batch size is set to 32, and the network is trained using the Adam optimizer. The initial value of λᵢ is set to 0.5, and the margin value for rank normalization of the importance weight is set to 0.1. In addition, γ₁ and γ₂, which are parameters for balancing the loss function, are set to 0.01 and 0.05 respectively.

As shown in FIG. 5, the model performs the label distribution learning using only facial-specific augmentation without additional information, and shown performance that exceed existing methods on the RAF-DB, SFEW, AffectNet datasets. As a result, it can be seen that the existing FER data set suffers from uncertainty and ambiguity problems, and strategies to solve them make the model more robust.

It is difficult to accurately recognize facial expressions in images with ambiguous facial expressions or uncertain visual features, and thus there are many noise labels. Therefore, noise labels were added to the training dataset to test the robustness against noise labels. The injection of noise labels was performed using existing research methods. A specific percentage of samples (e.g., 10%, 20%, 30%) were randomly selected from the entire dataset, and change them to random labels different from the original labels.

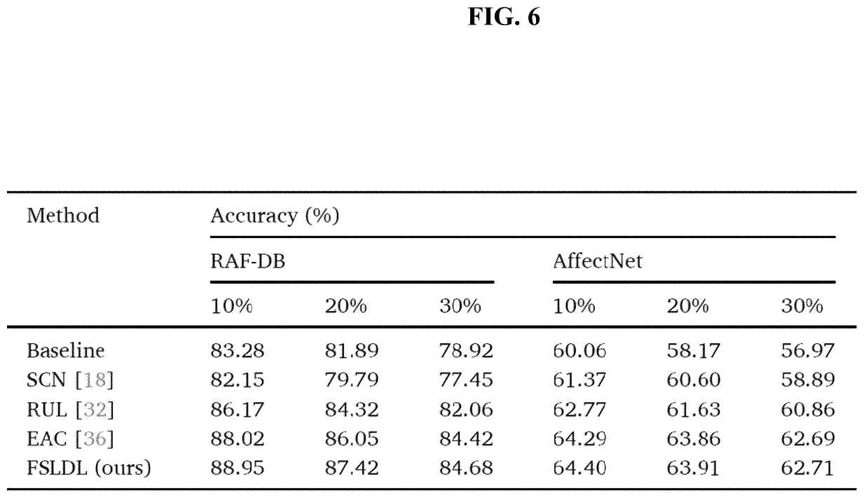

FIG. 6 is a diagram comparing the results of injecting noise labels at a specific rate into the RAF-DB and AffectNet datasets.

As shown in FIG. 6, the model applying label distribution learning according to an embodiment of the present disclosure outperforms the existing methods in all noise ratio scenarios.

In addition, in the case of the RAF-DB dataset, when noise labels were injected at 10%, 20%, and 30% rates, the model applying label distribution learning according to an embodiment of the present disclosure showed accuracy improvements of 5.67%, 5.53%, and 5.76%, respectively, compared to the existing methods, demonstrating its effectiveness.

Similarly, in the AffectNet dataset, the model applying label distribution learning according to an embodiment of the present disclosure shows better performance in various scenarios where noise labels are injected at specific rates. That is, the model applying label distribution learning according to an embodiment of the present disclosure demonstrates robustness against noise labels.

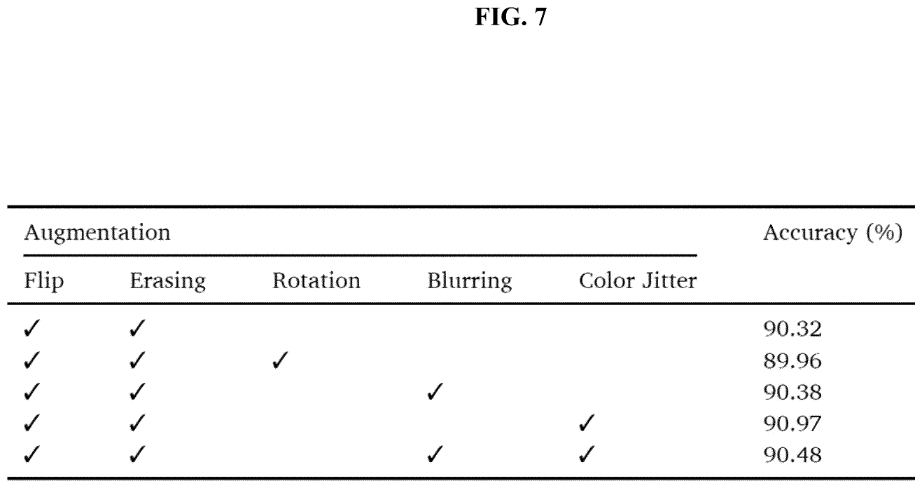

FIG. 7 is a diagram showing the results of applying different augmentation methods.

An experiment was conducted to fine a face-specific augmentation method for facial expressions. Various augmentation techniques were used to generate augmented samples, and these were used to generate the target label distribution.

For example, the augmentation techniques such as horizontal flipping for mirroring the image, erasing that erases a specific part, rotation for rotating the image at certain angles, blurring for making the image blurry, and color jitter for changing the color conditions of image were used. Through a combination of various augmentation techniques, an optimized combination for facial expressions was found.

All augmentation techniques are applied randomly, and horizontal flip and erase are used. Rotation is not effective for FER as FER datasets are mainly frontal faces. However, color jitter is effective because the color condition does not affect facial expressions. Also, since the blurred image makes the expression more ambiguous, it is not very helpful in making the label distribution. Therefore, in an embodiment of the present disclosure, horizontal flipping, erasing, and color jitter were used as augmentation methods specialized for facial expressions. Since augmented samples allow for the analysis of facial expressions from various perspectives, a more sophisticated label distribution can be created by integrating the prediction distribution for them.

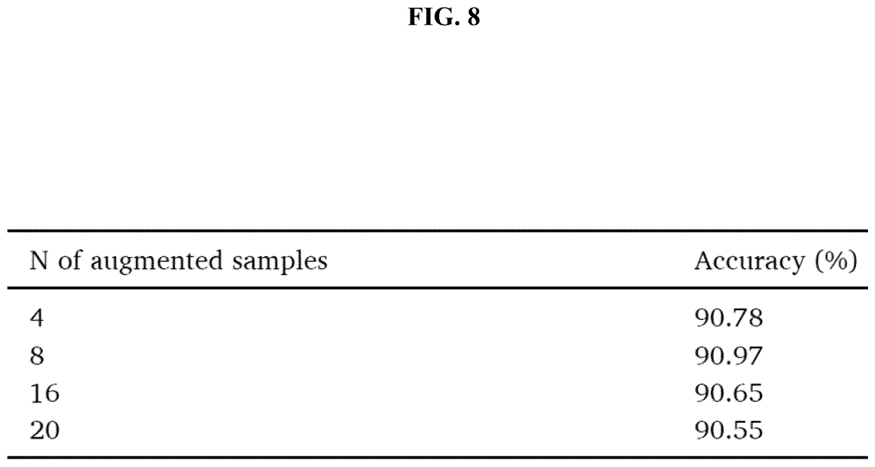

FIG. 8 is a diagram comparing of the label distribution learning results according to the number of augmented samples.

To examine the effect of the number of augmented samples used to generate the target label distribution, a comparative experiment was conducted with different numbers of augmented samples under the same setting. As shown in FIG. 8, it can be seen that the performance is better when the number of augmented samples is set to 8 than when the number of augmented samples is set to 4. However, when the number of augmented samples becomes exceeds 8, the accuracy decreases, which is a problem caused by too many augmented samples participating in the process of creating a new target label distribution. The sum of the importance weights is 1, and as the number of augmented samples increases, the weight of the sample with high importance decreases. Therefore, the appropriate number of augmented samples k is set to 8 through experiments.

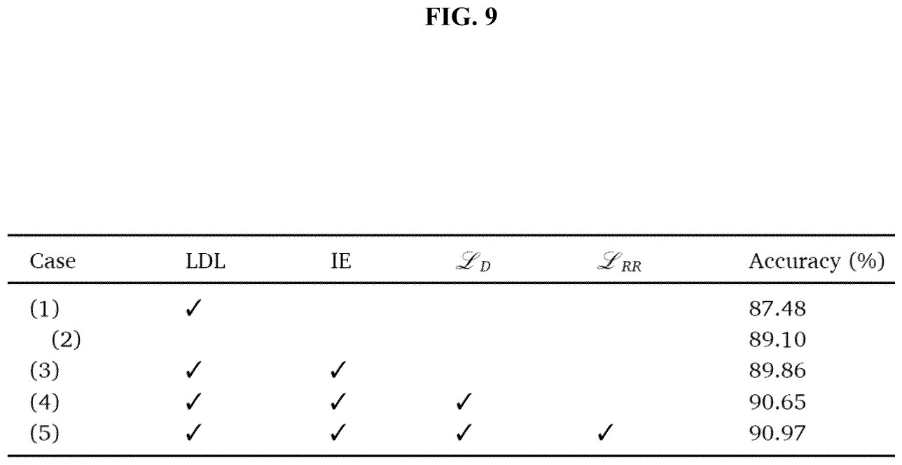

FIG. 9 is a diagram showing the results of evaluating the component of the model. In FIG. 9, experiments were conducted by sequentially adding each component of the model. The components to be evaluated are the label distribution learning, the importance extractor, the rank regularization loss function ( [symbol] ) and the discriminative loss function ( [symbol] ).

In FIG. 9, case (1) is the result of learning with one-hot labels without label distribution learning, and case (2) produces a target label distribution, but with equal weighting for all augmented samples except for the importance extractor. Case (3) is weighted according to learning using an importance extractor. Case (4) is an experiment using the discriminative loss function additionally. Case (5) additionally uses a rank regularization loss function to better represent the importance of augmented samples. As showing in FIG. 9, it is confirmed that the best performance is obtained from the combined combination of all components.

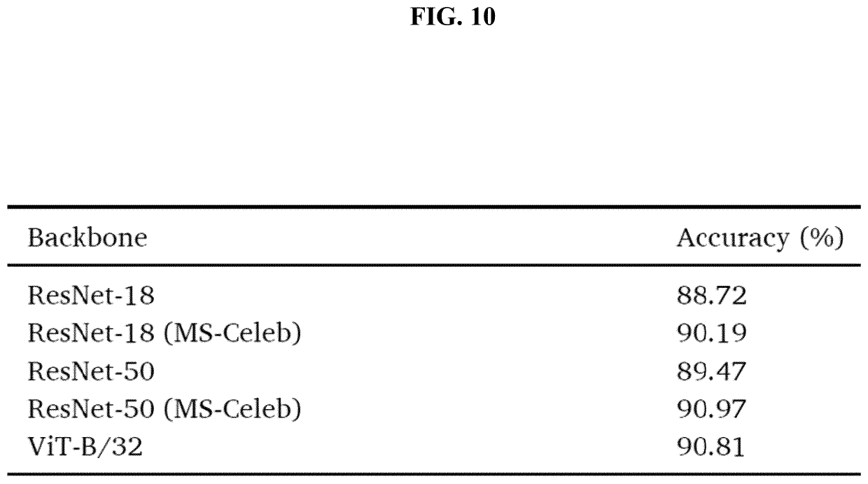

FIG. 10 is a diagram comparing the results of applying different backbone networks to the model. The backbone network is important in order to extract facial expression features well from static facial samples.

To evaluate the effectiveness of the backbone network used for feature extraction of input samples in the model according to an embodiment of the present disclosure, ResNet-18 and ResNet-50 were used as backbones, and ViT-B/32 was included to verify the effectiveness of the model according to an embodiment of the present disclosure across various types of backbones.

In addition, pre-trained ResNet with the MS-Celeb-1 M is used to extract facial features well. In the case of ViT-B/32, the pre-trained CLIP was used because it is agnostic and robust to various domains.

As showing in the FIG. 10, ResNet-50 achieved higher performance compared to ResNet-18, and better feature extraction was achieved with the model pre-trained on MS-Celeb-1M. Also, the accuracy when using ViT-B/32 as the backbone was similar to that of ResNet-50 (MSCeleb-1 M), but it showed more balanced performance across all classes. In particular, it showed balanced results for classes such as fear or disgust.

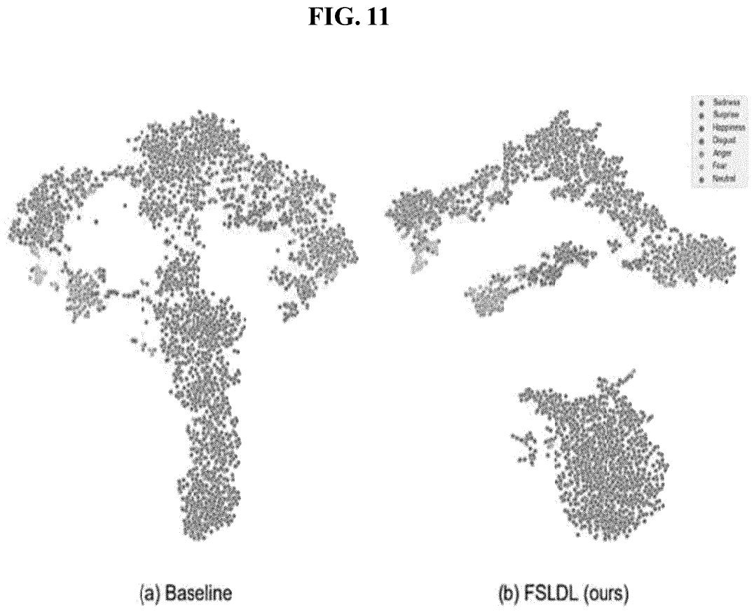

FIG. 11 is a diagram showing the result of visualizing the feature distribution of the baseline model (existing model) and the model according to an embodiment of the present disclosure.

As showing in FIG. 11, the features of the model trained through label distribution learning according to an embodiment of the present disclosure are better clustered for each class compared to the baseline model (existing model).

And, the feature distribution generated by the model trained through label distribution learning according to an embodiment of the present disclosure exhibit clearer boundaries between different classes, while the feature distributions from the baseline model appear relatively ambiguous. In addition, the model trained through label distribution learning according to an embodiment of the present disclosure tends to cluster relatively similar classes more closely than the baseline. Through the visualization results, it can be seen that the method according to an embodiment of the present disclosure for processing noisy label data can perform effective emotion classification.

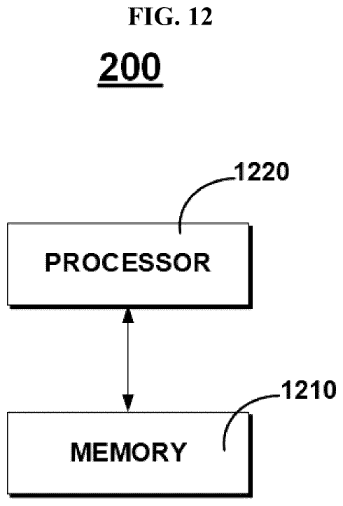

FIG. 12 is a block diagram schematically illustrating an internal configuration of a computing device for performing a facial expression recognition method through label distribution learning according to an embodiment of the present disclosure.

Referring to FIG. 12, a computing device (200) according to an embodiment of the present disclosure is configured to include a memory (1210) and a processor (1220).

The memory (1210) stores various commands (program codes) for performing a facial expression recognition method through label distribution learning according to an embodiment of the present disclosure.

The processor (1220) can execute the command stored in the memory (1210). The commands executed by the processor (1220) may perform a series of processes, including preprocessing an input sample during the training process to generate a plurality of augmented samples, using the augmented samples to generate the target label distribution for the input sample to supervise the model's learning, and, after the training is completed, inputting a single facial sample into the trained model without using the augmented samples during the inference process to output a facial expression recognition result. This is the same as that described with reference to FIG. 2, so repeated description is omitted.

The device and method according to the embodiments of the present disclosure may be implemented in a program that can be executed by various computers and may be recorded on computer-readable media. The computer-readable media may include program commands, data files, and data structures individually or in combinations thereof. The program commands that are recorded on a computer-readable media may be those specifically designed and configured for the present disclosure or may be those known to those engaged in the computer software field and thus available. The computer-readable recording media include magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands include not only machine language codes compiled by a compiler, but also high-level language code that can be executed by a computer using an interpreter, etc.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A facial expression recognition method through label distribution learning, comprising:
(a) in the training process, preprocessing an input sample to generate a plurality of augmented samples, creating a target label distribution for the input sample using the plurality of augmented samples, and training a model using supervised learning; and
(b) after the training is completed, during the inference process, outputting a facial expression recognition result by inputting a single facial sample into the trained model without using the augmented samples.

2. The facial expression recognition method through label distribution learning of claim 1, wherein the step (a) includes:
extracting a facial feature and a plurality of augmented facial features by inputting the input sample and the plurality of augmented samples into backbone network of the model, respectively;
calculating an importance weight for each of the plurality of augmented samples using the facial feature and the plurality of augmented facial features; and
generating a target label distribution for emotion classes by reflecting the importance weight for each augmented sample based on the facial feature and the plurality of augmented facial features, and using the generated target label distribution to supervise the training of the model.

3. The facial expression recognition method through label distribution learning of claim 2, wherein the step generating the target label distribution comprises:
generating a predicted label distribution for each of the plurality of augmented samples by inputting the plurality of augmented facial features corresponding to each of plurality of augmented samples into the fully connected layer, respectively;
generating the target label distribution by calculating a weighted sum using between the predicted label distribution and importance weight for each of the plurality of augmented samples, and then normalizing the result; and
generating a final target label distribution for the input sample by reflecting one-hot label of the input sample in the target label distribution, considering an uncertainty score of the input sample.

4. The facial expression recognition method through label distribution learning of claim 2, wherein the step calculating importance weight for each augmented sample for comprises:
calculating importance weight for each of the augmented samples by combining each augmented facial feature with the facial feature, respectively, and inputting the combined result into an importance feature extractor; and
normalizing the importance weight for each of the augmented samples by sorting the importance weights of each augmented sample in descending order and dividing them two groups, calculating the weighted average of the importance weights for each group, and adjusting the importance weights such that the weighted averages of the two groups have a minimum margin.

5. The facial expression recognition method through label distribution learning of claim 2,
wherein the model is trained by adding a loss term to a loss function so that the distance between emotion class-centered vectors becomes larger.

6. A computing device, comprising:
a memory storing at least one command; and
a processor executing commands stored in the memory,
wherein the commands executed by the processor respectively perform:
(a) in the training process, preprocessing an input sample to generate a plurality of augmented samples, creating a target label distribution for the input sample using the plurality of augmented samples, and training a model using supervised learning; and
(b) after the training is completed, during the inference process, outputting a facial expression recognition result by inputting a single facial sample into the trained model without using the augmented samples.

7. The computing device of claim 6, wherein the step of supervised learning said model comprises:
extracting a facial feature and a plurality of augmented facial features by inputting the input sample and the plurality of augmented samples into a backbone network of the model, respectively;
calculating an importance weight for each of the plurality of augmented samples using the facial feature and the plurality of augmented facial features; and
generating a target label distribution for emotion classes by reflecting the importance weight for each augmented sample based on the facial feature and the plurality of augmented facial features, and using the generated target label distribution to supervise the training of the model.

8. The computing device of claim 7, wherein the step generating the target label distribution comprises:
generating a predicted label distribution for each of the plurality of augmented samples by inputting the plurality of augmented facial features corresponding to each of plurality of augmented samples into the fully connected layer, respectively;
generating the target label distribution by calculating a weighted sum using between the predicted label distribution and importance weight for each of the plurality of augmented samples, and then normalizing the result; and
generating a final target label distribution for the input sample by reflecting one-hot label of the input sample in the target label distribution, considering an uncertainty score of the input sample.

9. The computing device of claim 7, wherein the step calculating importance weight for each augmented sample for comprises:
calculating importance weight for each of the augmented samples by combining each augmented facial feature with the facial feature, respectively, and inputting the combined result into an importance feature extractor; and
normalizing the importance weight for each of the augmented samples by sorting the importance weights of each augmented sample in descending order and dividing them two groups, calculating the weighted average of the importance weights for each group, and adjusting the importance weights such that the weighted averages of the two groups have a minimum margin.
